(19) United States
(12) Patent Application Publication
(10) Pub. No.: US 2015/0139463 A1
(43) Pub. Date: May 21, 2015

(54) COMBINED AUDIO SPEAKER AND FOG MACHINE

(71) Applicant: Rony Samimrad, Los Angeles, CA (US)

(72) Inventor: Rony Samimrad, Los Angeles, CA (US)

(21) Appl. No.: 14/083,870

(22) Filed: Nov. 19, 2013

(51) Int. Cl. H04R 1/02; B01F 3/04; G08C 17/02

(52) U.S. Cl. CPC H04R 1/028; G08C 17/02; B01F 3/04007
USPC 381/334

(57) ABSTRACT

A combination audio speaker and fog machine wherein at least one audio speaker in mounted in a housing, a fog machine mounted in the housing having an outlet for emitting fog disposed below the audio speaker.

### CROSS-REFERENCE TO RELATED APPLICATION

Not Applicable.

### BACKGROUND OF THE INVENTION

1. Technical Field

The invention relates to audio speakers, and, more particularly, to a combination audio speaker system mounted in a housing with a fog machine associated therewith.

2. Background Art

Fog machines for generating a fog-like atmosphere are well known and used in the movie and music industries. Audio speakers mounted in a speaker housing are also well known. However, such speakers having the ability to generate a fog are not known. There is a need for such a fog machine and audio speaker system combination.

### BRIEF SUMMARY OF THE INVENTION

It is an object of this invention to provide a combination fog machine audio speaker system.

These and other objects are preferably accomplished by providing a speaker housing having one or more audio speakers mounted in the housing, the housing having a fog machine mounted therein adapted to emit fog when desired.

### BRIEF DESCRIPTION OF THE SEVERAL VIEWS OF THE DRAWINGS

FIG. 1 is an exploded view showing a remote control and a speaker housing in accordance with the teachings of the invention;

FIG. 2 is a perspective view of the housing above FIG. 1, the front panel being removed for convenience of illustration; and

FIG. 3 is a rear elevational view of the housing alone of FIGS. 1 and 2.

### DETAILED DESCRIPTION OF THE INVENTION

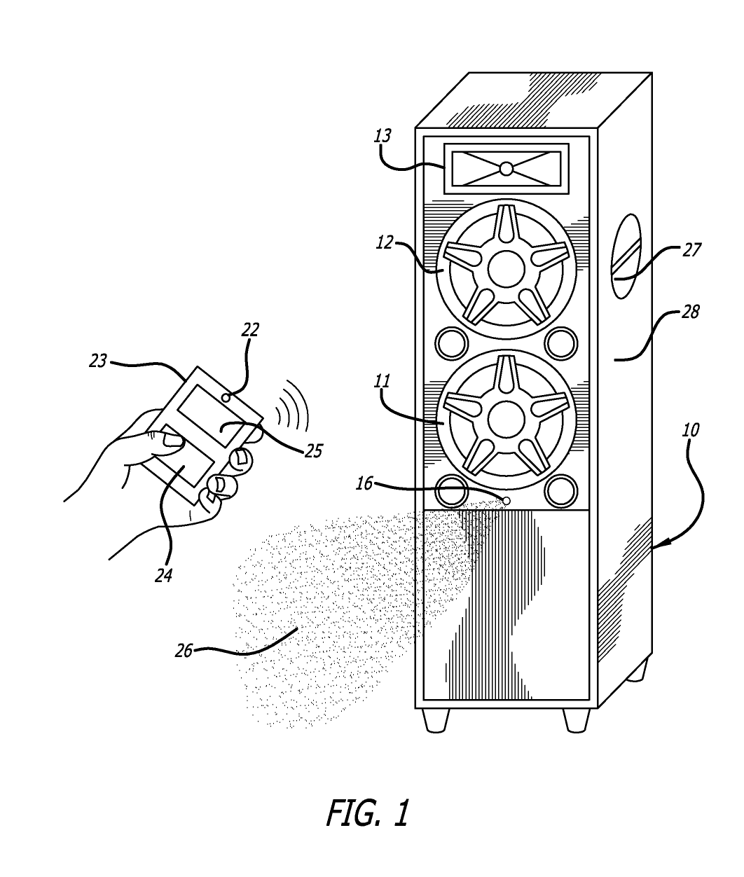

Referring now to FIG. 1 of the drawing, an audio speaker housing 10 is shown having one or more speakers mounted therein, such as speakers 11, 12. A tweeter speaker 13 is shown at top.

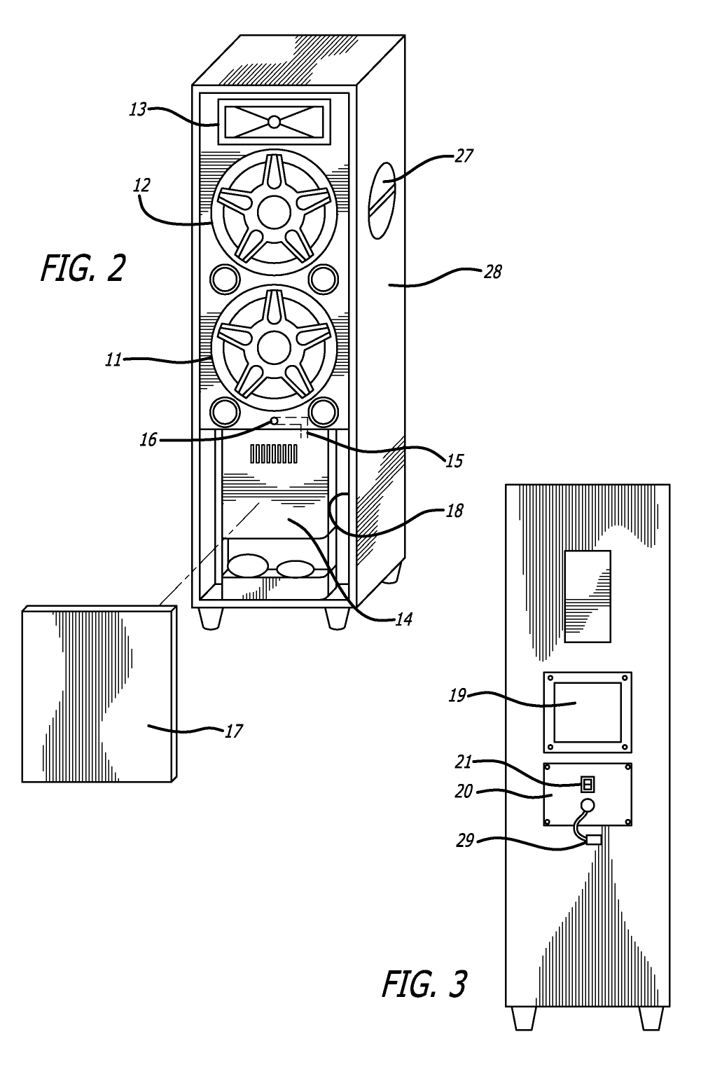

A fog machine 14 (FIG. 2) is mounted within housing 10 between speaker 11. Fog machine 14 has an outlet tube 15, shown in dotted lines, communicating at one end with fog machine 14 and at the other end with an outlet orifice 16, in housing 10, below speaker 11. A removable panel 17 closes off the compartment 18 in which fog machine 14 is mounted. A handle 27 may be provided in side wall 28.

As seen in FIG. 3, a back panel 19 secures machine 14 within compartment 18. A control panel 20 is mounted below panel 19 and an on-off switch 21 turns machine 14 on and off. A red light indicator 22 (FIG. 1) on remote control 23 turns on when the on-off switch 21 is on. Remote control 23 has an on button 24 and an off button 25 above button 24 in electronic communication with a radio receiver 29 (FIG. 3) associated with the on/off switch 21. When button 24 is pressed, fog 26 is emitted from fog machine 14 out of orifice 16.

Any suitable fog machine may be used, such as the 900W Fog Machine manufactured and sold by GUANGZHOU Yuangyang Audio Co., Ltd. of Guangzhou City, Guangdong Province, 5 10800, the Republic of China.

Although a particular embodiment of the invention is disclosed, variations thereof may occur to an artisan and the scope of the invention should only be limited by the scope of the appended claim.

1. A combination audio speaker housing and fog machine comprising:
An audio speaker housing;
At least one audio speaker mounted in said housing; and
A fog machine mounted in said housing, said fog machine having an outlet for emitting fog from said machine out of an orifice in said audio speaker housing.

2. The combination of claim 1 wherein said orifice is adjacent to said speaker.

3. The combination of claim 2 wherein said orifice opens to the atmosphere below said speaker.

4. The combination of claim 1 wherein an on/off switch is coupled to said fog machine mounted on said audio speaker housing.

5. The combination of claim 4 wherein a remote control is provided adapted to communicate electronically with said on/off switch to activate said fog machine when said on/off switch is in its on position.

6. The combination of claim 5 including a light mounted on said remote control adapted to light up when said switch is in said on position.
